(19) United States
(12) Patent Application Publication
(10) Pub. No.: US 2009/0151831 A1
(43) Pub. Date: Jun. 18, 2009

(54) TIRE WITH TREAD RUBBER COMPOSITION WHICH CONTAINS DUAL SILICA MOIETIES

(76) Inventors: Paul Harry Sandstrom, Cuyahoga Falls, OH (US); Kuo-Chih Hua, Richfield, OH (US); Shingo Futamura, Wadsworth, OH (US); Kenneth Allen Bates, Brunswick, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/957,751

(22) Filed: Dec. 17, 2007

(51) Int. Cl. C08K 5/5415; B60C 1/00

(52) U.S. Cl. 152/209.1; 524/261

(57) ABSTRACT

The invention relates to a tire having a tread of a cured rubber composition which contains dual silica moieties in a sense of containing both hydrophilic precipitated silica and in situ hydrophobated precipitated silica.

### FIELD OF INVENTION

The invention relates to a tire having a tread of a cured rubber composition which contains dual silica moieties in a sense of containing both hydrophilic precipitated silica and pre-hydrophobated precipitated silica.

### BACKGROUND OF THE INVENTION

Tires have previously been proposed which have treads of a rubber composition which contain hydrophilic silica or which contain pre-hydrophobated precipitated silica which has been hydrophobated prior to addition to the elastomer host. For example, see U.S. Pat. Nos. 4,474,908, 5,780,538, 6,127,468 and 6,573,324 and U.S. Patent Application No. 2005/0009955.

A significant aspect of this invention is to provide a tire tread of a rubber composition which contains a combination of hydrophilic precipitated silica and pre-hydrophobated precipitated silica which has been hydrophobated prior to addition to the elastomer host. In other words, such tire tread rubber composition contains dual silica moieties in a sense of containing both hydrophilic precipitated silica and pre-hydrophobated precipitated silica.

Use of a combination of pre-hydrophobated precipitated silica (hydrophobated prior to addition to the elastomer host) together with hydrophilic precipitated silica for a tire tread rubber composition is significantly different from use of a combination of in situ hydrophobated precipitated silica (hydrophobated in situ within the elastomer host) together with hydrophilic precipitated silica for a tire tread rubber composition.

In particular, the silica pre-hydrophobation process is significantly different from the silica in situ hydrophobation process to thereby yield a different overall product.

For example, for the pre-hydrophobation process, the precipitated silica is hydrophobated with a hydrophobation agent containing an alkoxysilane moiety in the absence of, and therefore isolated from, the elastomer composition, whereas the in situ hydrophobation process requires the presence of a combination of precipitated silica, hydrophobation agent which contains an alkoxysilane moiety and elastomer in which an alcohol byproduct from the in situ hydrophobation is introduced into the rubber composition to thereby yield a different overall product for the tire tread rubber composition.

Further, when using the pre-hydrophobated silica as compared to using an in situ hydrophobated silica, the hydrophilic silica can be added to the rubber composition before, after, or simultaneously with the pre-hydrophobated silica and substantially maintain its hydrophilic nature which is a unique feature of this invention.

In one embodiment of the invention, the pre-hydrophobated precipitated silica is a hydrophilic precipitated silica which has been hydrophobated by pre-treatment with, for example, at least one of an alkoxysilane, organoalkoxysilyl polysulfide (silica coupling agent) and organomercaptoalkoxylsilane (silica coupling agent), alternately by pre-treatment with an organoalkoxysilyl polysulfide (silica coupling agent) or organomercaptoalkoxylsilane (silica coupling agent) which may optionally also include an alkoxysilane, prior to addition to the rubber composition.

The hydrophilic precipitated silica is a precipitated silica which has not been hydrophobated with a hydrophobtaining agent, particularly not hydrophobated with a silane based hydrophobtaining agent, particularly a siloxane-containing hydrophobtaining agent for the hydrophilic precipitated silica.

In practice, it is considered herein that the rubber reinforcement contribution of such pre-hydrophobated precipitated silica is different than a rubber reinforcement contribution of the hydrophilic precipitated silica, where the precipitated silica has been pre-hydrophobated (prior to its addition to the rubber composition) with said at least one of alkoxysilane, organoalkoxysilyl polysulfide and organomercaptoalkoxysilane.

Historically, synthetic amorphous precipitated silica is typically hydrophilic (water loving) in nature and therefore not readily compatible with diene-based elastomers in rubber compositions in general. For this reason, for rubber compositions which contain a significant precipitated silica content, it is often desirable to provide the precipitated silica in a pre-hydrophobated form to the elastomer host to make it more compatible with diene-based elastomers in a rubber composition for a tire tread.

For this invention, while the mechanism is not fully understood, it has been observed that use of a combination of dual precipitated silica moieties, namely a combination of pre-hydrophobated precipitated silica, particularly when pre-hydrophobated with an organoalkoxysilyl polysulfide or organomercaptoalkoxysilane coupling agent, (prior to its addition to the rubber composition) and hydrophilic precipitated silica, in a diene-based elastomer tire tread composition can beneficially provide a tire tread with one or more physical properties which are different than when using only such pre-hydrophobated precipitated silica or when only using such hydrophilic precipitated silica. For example, it has been observed that a tire tread running surface having a relatively high wet coefficient of friction can be obtained by using such combination of dual silica moieties as compared to a tire tread containing a significant pre-hydrophobated precipitated silica content (particularly when pre-hydrophobated with such silica coupling agent) without the presence of a hydrophilic precipitated silica. Apparently the silica coupling agent pre-treated precipitated silica acts to enhance desirable physical properties of the tire tread rubber composition, whereas the hydrophilic precipitated silica does little to enhance the tread rubber physical properties in the manner of the pre-hydrophobic precipitated silica but, instead, particularly enhances the wet coefficient of friction of the tread rubber running surface in a manner which is significantly better than obtained with the pre-hydrophobated silica.

Accordingly, while the mechanism may not be completely understood, it is envisioned that the pre-hydrophobated precipitated silica enhances desirable physical properties and that the hydrophilic (“water loving”) precipitated silica can beneficially enhance an increase in wet traction of the tread rubber surface and therefore beneficial for a tire tread in a sense of traction performance for wet driving conditions.

It is considered herein that use of such dual silica moieties in a tire tread is novel and a departure from past practice.

A challenge is therefore presented as to how to suitably obtain a combination of such dual silica moieties in a tire tread rubber composition.

In the description of this invention, the term “phr” relates to parts by weight for a material or ingredient per 100 parts by weight elastomer(s)”. The terms “rubber” and “elastomer” may be used interchangeably unless otherwise indicated. The terms “cure” and “vulcanize” may be used interchangeably unless otherwise indicated.

### SUMMARY AND PRACTICE OF THE INVENTION

In accordance with this invention, a tire is provided with a circumferential rubber tread including the running surface of the tire tread, of a rubber composition which contains dual silica moieties comprised of a combination of pre-hydrophobated precipitated silica, (having been hydrophobated prior to its addition to the elastomer host), and hydrophilic precipitated silica.

Such pre-hydrophobated precipitated silica is a hydrophilic precipitated silica which is hydrophobated prior to its addition to the rubber composition.

In practice, said precipitated silica may be hydrophobated prior to its addition to the rubber composition by treatment with, for example, at least one of alkoxysilane, organosiloxysilyl polysulfide (a silica coupling agent) and organomercaptoalkoxysilane (a silica coupling agent), alternately with an organosiloxysilyl polysulfide (silica coupling agent) or organomercaptoalkoxysilane (silica coupling agent) which may optionally also include an alkoxysilane.

In one embodiment, said tire tread rubber composition is comprised of, based upon parts by weight per 100 parts by weight of rubber (phr):

(A) at least one conjugated diene-based elastomer, and

(B) about 30 to about 120 phr of reinforcing filler comprised of:
(1) about 30 to about 120 phr of precipitated silica, or
(2) a combination of precipitated silica and rubber reinforcing carbon black comprised of about 30 to about 120 phr of precipitated silica and up to about 60 phr of rubber reinforcing carbon black;
wherein said precipitated silica is comprised of:
   (a) about 20 to about 80, alternately from about 20 to about 50, weight percent of pre-hydrophobated precipitated silica (hydrophobated prior to addition to the diene-based elastomer), and
   (b) about 80 to about 20, alternately from about 80 to about 50, weight percent hydrophilic precipitated silica;
   wherein said pre-hydrophobated precipitated silica is hydrophobated prior to its addition to the rubber composition by treatment with:
      (1) an alkoxysilane, or
      (2) a combination of an alkoxysilane and at least one of an organoalkoxysilyl polysulfide and organomercaptoalkoxysilane, or
      (3) at least one of an organoalkoxysilyl polysulfide and organomercaptoalkoxysilane.

In one embodiment, the weight ratio of hydrophilic precipitated silica to pre-hydrophobated precipitated silica is at least 1/1, alternately at least 2/1, where a balance between cured tread rubber physical properties contributed by the presence of the pre-hydrophobated precipitated silica and tread surface wet coefficient of friction separately contributed by the presence of the hydrophilic precipitated silica is desired.

In one embodiment, a method of preparation of the dual moiety precipitated silica reinforced rubber composition for a tire tread is provided which comprises mixing a combination of pre-hydrophobated precipitated silica and hydrophilic precipitated silica with a rubber composition containing at one conjugated diene-based elastomer, without an addition of a silica coupling agent or alkoxysilane silica hydrophobtaining agent to the rubber composition (so that the afore said dual moieties of precipitated silica is provided, namely so that the added hydrophilic silica remains primarily hydrophilic in nature);

wherein said pre-hydrophobated precipitated silica is a precipitated silica having been hydrophobated prior to its addition to the elastomer host.

For example, a method of preparation of a precipitated silica reinforced rubber composition for a tire tread is provided which is comprised of at least two preparatory non-productive mixing steps followed by a productive mixing step, which comprises, based upon parts by weight per 100 parts by weight rubber (phr):

(A) blending a pre-hydrophobated precipitated silica with a rubber composition comprised of at least one conjugated diene-based elastomer in at least one preparatory non-productive mixing step in an internal rubber mixer, (at a temperature of, for example, in a range of from about 135° C. to about 175° C.);

(B) removing said pre-hydrophobated precipitated silica-containing rubber composition from its internal rubber mixer, (and allowing said rubber composition to thereafter cool to a temperature below about 40° C.);

(C) blending a hydrophilic precipitated silica with said pre-hydrophobated precipitated silica-containing rubber composition in at least one different and subsequent preparatory non-productive mixing step (subsequent to said preparatory non-productive mixing step in which said pre-hydrophobated precipitated silica is added) in an internal rubber mixer, (in the absence of addition of a silane-containing hydrophobtaining agent for said hydrophilic precipitated silica) to form a rubber composition which contains dual silica moieties in a form of a combination of said pre-hydrophobated precipitated silica and said hydrophilic precipitated silica,

wherein said pre-hydrophobated silica is hydrophobated prior to its addition to said rubber composition with at least one hydrophobtaining agent comprised of an alkoxysilane, organosiloxysilyl polysulfide and organomercaptoalkoxysilane.

For example, a method of preparation of a precipitated silica reinforced rubber composition for a tire tread is provided comprised of at least one preparatory non-productive mixing step followed by a productive mixing step, which comprises, based upon parts by weight per 100 parts by weight rubber (phr):

(A) blending a pre-hydrophobated precipitated silica with a rubber composition comprised of at least one conjugated diene-based elastomer in at least one preparatory non-productive mixing step in an internal rubber mixer, (at a temperature of, for example, in a range of from about 135° C. to about 175° C.);

(B) blending a hydrophilic precipitated silica with said pre-hydrophobated precipitated silica-containing rubber composition in the same non-productive mixing step (before or after the addition of said pre-hydrophobated silica) in an internal rubber mixer, (in the absence of addition of a silane-containing hydrophobtaining agent for said hydrophilic additional precipitated silica) to form a rubber composition which contains dual silica moieties in a form of a combination of said pre-hydrophobated precipitated silica and said hydrophilic precipitated silica,

wherein said pre-hydrophobated silica is hydrophobated prior to its addition to said rubber composition with at least one hydrophobtaining agent comprised of an alkoxysilane, organosiloxysilyl polysulfide and organomercaptoalkoxysilane.

In practice, the mixing of the hydrophilic precipitated silica can be administered for example:

(A) in the same non-productive mixing step before or after the addition of the pre-hydrophobated precipitated silica, or

(B) in a separate non-productive mixing step following the addition of the pre-hydrophobated precipitated silica, or

(C) in a separate non-productive mixing step following the addition of the pre-hydrophobated precipitated silica with an additional separate non-productive mixing step therebetween, or

(D) in a separate, subsequent productive mixing step in which sulfur and sulfur curatives are added to the rubber composition.

In practice, as hereinbefore indicated, said hydrophobtaining agent for pre-hydrophobtaining said hydrophilic precipitated silica for the purposes of this invention, is at least one of alkoxysilane, organosiloxysilyl polysulfide and organomercaptoalkoxysilane, alternately with said organosiloxysilyl polysulfide or organomercaptoalkoxysilane which may optionally include said alkoxysilane.

In practice, representative of said organoalkoxysilyl polysulfides is, for example, a bis(3-trialkoxysilylpropyl)polysulfide having an average of from about 2 to about 3.8, optionally from about 2 to about 2.6, sulfur atoms in its polysulfidic bridge. Exemplary of said bis(3-trialkoxysilylalkyl)polysulfide is comprised of a bis(3-triethoxysilylpropyl)polysulfide.

In practice, representative of said alkoxysilane is, for example, an alkoxysilane of the general formula (I):

Zₙ-Si—R₄₋ₙ (I)

wherein R is a saturated alkyl radical having from one to 18, preferably from one to 8, carbon atoms such as, for example, methyl, ethyl, isopropyl, n-butyl and octadecyl radicals, n is a value of from 1 to 3 and Z is an alkoxy radical represented as (R¹O)—, wherein R¹ is a saturated alkyl radical having from one to 3 carbon atoms such as, for example, methyl, ethyl and isopropyl radicals, preferably at least one of methyl and ethyl radicals.

Representative examples of alkoxysilanes of Formula (I) are, for example, trimethoxy methyl silane, dimethoxy dimethyl silane, methoxy trimethyl silane, trimethoxy propyl silane, trimethoxy octyl silane, trimethoxy hexadecyl silane, dimethoxy dipropyl silane, triethoxy methyl silane, triethoxy propyl silane, triethoxy octyl silane, and diethoxy dimethyl silane.

Accordingly, said alkoxysilanes have an alkoxy group being reactive with the hydroxyl groups (e.g. silanol groups) contained on the surface of the precipitated silica aggregates.

In the practice of this invention, the tread of the tire may be a rubber composition comprised of various conjugated diene based elastomers. Such diene-based elastomers may be polymers and copolymers of conjugated dienes, such as, for example, isoprene and 1,3-butadiene, and copolymers of at least one conjugated diene hydrocarbon and vinyl aromatic compound selected from styrene and alphamethyl styrene, preferably styrene.

For example, representative of such elastomers are natural cis 1,4-polyisoprene rubber, synthetic cis 1,4-polyisoprene rubber, c is 1,4-polybutadiene rubber, high vinyl polybutadiene rubber having a vinyl 1,2 content in a range of about 10 percent to about 90 percent, styrene/butadiene copolymer (SBR) rubber (aqueous emulsion or organic solution polymerization prepared copolymers) and including organic solvent polymerization prepared SBR having a vinyl 1,2-content in a range of about 10 to about 90 percent based on its polybutadiene derived portion and a polystyrene content in a range of about 10 to about 60 percent based upon the copolymer, styrene/high trans 1,4-butadiene copolymer rubber having a trans-1,4 content in the range of about 40 to about 80 percent based on its polybutadiene derived portion, styrene/isoprene/butadiene terpolymer rubber, butadiene/acrylonitrile rubber, styrene/isoprene copolymer and isoprene/butadiene copolymer rubber, 3,4-polyisoprene rubber and trans 1,4-polybutadiene rubber.

Further representative of such elastomers are functionalized elastomers as, for example, amine and silane functionalized organic solution polymerization prepared styrene/butadiene copolymers (functionalized S-SBR's) and amine and silane functionalized organic solution polymerization prepared cis 1,4-polybutadiene elastomers may also be used.

Additional representative of such elastomers are, for example, organic solution polymerization prepared tin coupled elastomers such as for example, tin coupled styrene/butadiene copolymers may also be used.

Tin coupled copolymers of styrene/butadiene may be prepared, for example, by introducing a tin coupling agent during the styrene/1,3-butadiene monomer copolymerization reaction in an organic solvent solution, usually at or near the end of the polymerization reaction. Such coupling of styrene/butadiene copolymers is well known to those having skill in such art.

In practice, it is usually preferred that at least 50 percent and more generally in a range of about 60 to about 85 percent of the Sn (tin) bonds in the tin coupled elastomers are bonded to butadiene units of the styrene/butadiene copolymer to create Sn-dienyl bonds such as butadienyl bonds.

Creation of tin-dienyl bonds can be accomplished in a number of ways such as, for example, sequential addition of butadiene to the copolymerization system or use of modifiers to alter the styrene and/or butadiene reactivity ratios for the copolymerization. It is believed that such techniques, whether used with a batch or a continuous copolymerization system, is well know to those having skill in such art.

Various tin compounds, particularly organo tin compounds, may be used for the coupling of the elastomer. Representative of such compounds are, for example, alkyl tin trichloride, dialkyl tin dichloride, yielding variants of a tin coupled styrene/butadiene copolymer elastomer, although a trialkyl tin monochloride might be used which would yield simply a tin-terminated copolymer.

Examples of tin-modified, or coupled, elastomers are, for example, styrene/butadiene copolymer elastomers exemplified for example in U.S. Pat. No. 5,064,901.

Various commercially available amorphous synthetic silicas (precipitated silicas) may be added to the rubber composition for the reinforcement of the diene based elastomers. Such silicas may be characterized by the their BET and CTAB surface areas. Representative of such silicas, for example, only and without limitation, are silicas available from PPG Industries under the Hi-Sil trademark with designations 210, 243, etc.; silicas available from Rhodia, with designations of Zeosil 1165MP and Zeosil 165GR, silicas available from Degussa AG with designations VN2 and VN3, and silicas available from Huber such as Zeopol 8745 and Zeopol 8715.

It is readily understood by those having skill in the art that the rubber composition would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins and plasticizers, fillers, pigments, fatty acid, zinc oxide, waxes, antioxidants and antiozonants, peptizing agents and reinforcing materials.

The presence and relative amounts of the above additives are not considered to be an aspect of the present invention, unless otherwise indicated, which is more primarily directed to a tire with a tread, including the tread running surface, of a rubber composition containing dual silica moieties in a form of a pre-hydrophobated precipitated silica and hydropohilic precipitated silica.

The tires can be built, shaped, molded and cured by various methods which will be readily apparent to those having skill in such art.

The following Example is provided to further understand the invention. The parts and percentages are by weight unless otherwise indicated.

### EXAMPLE I

Experiments were conducted to evaluate the effect of pre-hydrophobated precipitated silica versus hydrophilic precipitated silica moieties on dry and wet coefficients of friction for a rubber composition without the presence of a silica coupling agent.

Pre-hydrophobated silica was pre-hydrophobated (prior to addition to the elastomer host) with an alkoxy silane and no silica coupling agent. Further, no alkoxysilane or silica coupling agent was added to the elastomer host during the mixing of the rubber composition in an internal rubber mixer.

It is to be appreciated that, if desired, the pre-hydrophobated silica could be hydrophobated with a silica coupler, prior to its addition to the elastomer host, so that it can couple to the silica.

It is to be further appreciated that the order of addition of the pre-hydrophobated precipitated silica and hydrophilic precipitated silica can be added in any order to the elastomer host, if desired.

Rubber compositions identified herein as rubber Samples A, B, C and D were prepared and the rubber Samples evaluated for wet and dry coefficients of friction (COF).

The rubber Samples were prepared by mixing polyisoprene rubber with reinforcing fillers, namely rubber reinforcing carbon black and hydrophilic precipitated silica together with a pre-hydrophobated silica in a first non-productive mixing stage (NP1) in an internal rubber mixer for about 4 minutes to a temperature of about 160° C. The resulting mixture was subsequently mixed in a second sequential non-productive mixing stage (NP2) in an internal rubber mixer to a temperature of about 160° C. to which a hydrophilic precipitated silica was added. The rubber composition was subsequently mixed in a productive mixing stage (P) in an internal rubber mixer with a sulfur cure package, namely sulfur and sulfur cure accelerator(s), for about 2 minutes to a temperature of about 115° C. The rubber composition is removed from its internal mixer after each mixing step and cooled to below 40° C. between each individual non-productive mixing stage and before the final productive mixing stage.

The basic formulation for the comparative rubber Samples A, B, C and D is presented in the following Table 1 expressed in parts by weight per 100 parts of rubber unless otherwise indicated.

TABLE 1

| Samples | | | |
|---|---|---|---|
| A | B | C | D |

First Non-Productive Mixing Stage (NP1)

| | | | | |
|---|---|---|---|---|
| Natural rubber¹ | 100 | 100 | 100 | 100 |
| Carbon black² | 20 | 20 | 20 | 20 |
| Processing oil | 6 | 6 | 6 | 6 |
| Fatty acid³ | 2 | 2 | 2 | 2 |
| Antidegradant(s)⁴ | 2 | 2 | 2 | 2 |
| Hydrophobated (pretreated) silica⁵ | 0 | 10 | 15 | 15 |
| Hydrophilic silica⁶ | 15 | 5 | 0 | 0 |
| Zinc oxide | 5 | 5 | 5 | 5 |

Second Non-Productive Mixing Stage (NP2)

| | | | | |
|---|---|---|---|---|
| Hydrophobated (pretreated) silica⁵ | 0 | 0 | 5 | 15 |
| Hydrophilic silica⁶ | 15 | 15 | 10 | 0 |

Productive Mixing Stage (P)

| | | | | |
|---|---|---|---|---|
| Sulfur | 1.4 | 1.4 | 1.4 | 1.4 |
| Accelerator(s)⁷ | 2.2 | 2.2 | 2.2 | 2.2 |

¹Cis 1,4-polyisoprene rubber (TRS20)
²N299, rubber reinforcing carbon black, ASTM identification
³Primarily stearic acid (at least 90 percent by weight stearic acid)
⁴Quinoline based antidegradant
⁵Precipitated silica pre-hydrophobated (pre)treated with an alkoxysilane
6Precipitated silica as HiSil 210 ™ from PPG Industries
⁷Sulfenamide and quanidine type of accelerators

The following Table 2 illustrates cure behavior and various physical properties of rubber compositions based upon the basic recipe of Table 1 and reported herein as a Control rubber Sample A and Samples B, C and D. Where cured rubber samples are examined, such as for the stress-strain, hot rebound and hardness values the rubber samples were cured for about 12 minutes at a temperature of about 170° C.

TABLE 2

| | Samples | | | |
|---|---|---|---|---|
| | Control | Invention | | |
| | A | B | C | D |
| Hydrophobated (pretreated) silica | 0 | 10 | 15 | 15 |
| (added in NP1) | | | | |
| Hydrophilic silica (added in NP1) | 15 | 5 | 0 | 0 |
| Hydrophobated (pretreated) silica | 0 | 0 | 5 | 15 |
| (added in NP2) | | | | |
| Hydrophilic silica (added in NP2) | 15 | 15 | 10 | 0 |
| Total hydrophobated silica | 0 | 10 | 20 | 30 |
| Total hydrophilic silica | 30 | 20 | 10 | 0 |
| Ratio of hydrophilic to | 30/0 | 20/10 | 10/20 | 0/30 |
| hydrophobated silica | | | | |

Coefficient of Friction¹

| | | | | |
|---|---|---|---|---|
| Wet substrate | 2.6 | 1.6 | 1.1 | 1.3 |
| (wet coefficient of friction) | | | | |
| Dry substrate | 2.8 | 2.8 | 2.9 | 2.9 |
| (dry coefficient of friction) | | | | |

Stress-strain, ATS², 14 min, 160° C.

| | | | | |
|---|---|---|---|---|
| Tensile strength (MPa) | 20.7 | 21.4 | 21.5 | 21.8 |
| Elongation at break (%) | 666 | 571 | 568 | 577 |
| 300% modulus, ring (MPa) | 3.9 | 6.6 | 6.5 | 6.3 |

Rebound

| | | | | |
|---|---|---|---|---|
| 23° C. | 46 | 50 | 52 | 53 |
| 100° C. | 60 | 66 | 69 | 69 |
| Shore A Hardness, 23° C. | 57 | 63 | 60 | 59 |
| Shore A Hardness, 100° C. | 53 | 60 | 58 | 57 |

RPA³ (100° C.), Storage Modulus G′, MPa

| | | | | |
|---|---|---|---|---|
| Uncured G′ 15% strain | 0.18 | 0.17 | 0.17 | 0.17 |
| Cured G′ modulus, 10% strain | 1.2 | 1.5 | 1.4 | 1.3 |

¹ASTM D-1894. A coefficient of friction (COF) value for a rubber sample may be measured, for example, on a Model SP-2000 Slip/Peel tester from IMASS Inc at 6 inches (about 15.2 cm) per minute using a 200 g sled against a substrate surface such as, for example, a polished aluminum surface.
²Automated Testing System (ATS) instrument by the Instron Corporation which can incorporate as many as six tests in one system. Such instrument may determine ultimate tensile, ultimate elongation, moduli, etc.
³Rubber Process Analyzer as RPA 2000TM instrument by Alpha Technologies

It can be seen in Table 2 that, for Control rubber Sample A where only a hydrophilic precipitated silica is used, the wet coefficient of friction for the rubber Sample is a suitable 2.6 and the dry coefficient of friction is 2.8.

It can be seen from Table 2 that addition of the pre-hydrophobated silica had little or no effect on the dry coefficient of friction as observed for rubber Samples B, C and D as compared to Control rubber Sample A

It can, however, further be seen from Table 2 that an inclusion of dual silica moieties in a sense of replacement of a portion of the hydrophilic precipitated silica with pre-hydrophobated precipitated silica resulted in a significant reduction of the wet coefficient of friction while significantly improving physical properties such as 300 percent modulus, rebound, Shore A hardness and cured G′ storage modulus for experimental rubber Samples B, C and D.

Therefore is it readily seen that the effect of the presence of the dual silica moieties in the sense of inclusion of the hydrophilic silica in a pre-hydrophobated silica-containing rubber composition had a separate and definitive effect on wet surface coefficient of friction which was significantly different from the effect on dry surface coefficient of friction.

It is concluded that where it is desired to promote both a suitable wet coefficient of friction for a tire tread running surface combined with suitable tread rubber physical properties, the dual silica moieties can be used for the rubber composition.

It is envisioned that the presence of the pre-hydrophobated precipitated silica promotes the rubber physical properties for the tread rubber and the presence of the hydrophilic precipitated silica promotes the wet coefficient of friction for the tread running (ground-contacting) surface.

For such purpose, a balance of pre-hydrophobated precipitated silica and hydrophilic precipitated silica contents are appropriate depending on the balance of wet coefficient of friction and rubber physical properties desired for a particular tire tread.

For this Example, a weight ratio of the dual silica moiety of hydrophilic precipitated silica to pre-hydrophobated silica appears to be important to balance the surface wet coefficient of friction and rubber composition physical properties as exemplified by Experimental rubber Samples B, C and D in comparison to the Control rubber Sample A.

Rubber Sample B of Table 2 is envisioned as presenting a better compromise, or balance, of wet coefficient of friction (contributed by the presence of the separate hydrophilic precipitated silica) and cured rubber physical properties (contributed by the separate pre-hydrophobated precipitated silica) in which a weight ratio of hydrophilic precipitated silica to pre-hydrophobated precipitated silica of 2/1 was used.

Accordingly, it is concluded that a threshold (minimum) weight ratio of the dual silica moieties of hydrophilic precipitated silica to the pre-hydrophobated precipitated silica may, for example, be at least 1/1 and more desirably at least about 2/1, for the dual moiety silica-reinforced tire tread rubber composition.

While certain representative embodiments and details have been shown for the purpose of illustrating the invention, it will be apparent to those skilled in this art that various changes and modifications may be made therein without departing from the spirit or scope of the invention.

What is claimed is:

1. A tire with a circumferential rubber tread including the running surface of the tire tread, of a rubber composition which contains dual silica moieties comprised of a combination of pre-hydrophobated precipitated silica and hydrophilic precipitated silica.

2. The tire of claim 1 wherein said pre-hydrophobated precipitated silica is hydrophobated prior to its addition to the rubber composition by treatment with at least one of alkoxysilane, organosiloxysilyl polysulfide and organomercaptoalkoxysilane.

3. The tire of claim 1 wherein said pre-hydrophobated precipitated silica is hydrophobated with at least one of organosiloxysilyl polysulfide and organomercaptoalkoxysilane.

4. The tire of claim 1 wherein said tire tread rubber composition is comprised of, based upon parts by weight per 100 parts by weight of rubber (phr):
(A) at least one conjugated diene-based elastomer, and
(B) about 30 to about 120 phr of reinforcing filler comprised of:
(1) about 30 to about 120 phr of precipitated silica, or
(2) a combination of precipitated silica and rubber reinforcing carbon black comprised of about 30 to about 120 phr of precipitated silica and up to about 60 phr of rubber reinforcing carbon black;
wherein said precipitated silica is comprised of:
(a) about 20 to about 80 weight percent of pre-hydrophobated precipitated silica, and
(b) about 80 to about 20 weight percent hydrophilic precipitated silica;
wherein said pre-hydrophobated precipitated silica is hydrophobated prior to its addition to the rubber composition by treatment with:
(1) an alkoxysilane, or
(2) a combination of an alkoxysilane and at least one of an organoalkoxysilyl polysulfide and organomercaptoalkoxysilane, or
(3) at least one of an organoalkoxysilyl polysulfide and organomercaptoalkoxysilane.

5. The tire of claim 4 wherein said wherein said precipitated silica is comprised of:
(A) about 20 to about 50 weight percent of pre-hydrophobated precipitated silica, and
(B) about 80 to about 50 weight percent hydrophilic precipitated silica.

6. A method of preparation of a dual moiety precipitated silica reinforced rubber composition for a tire tread which comprises mixing a combination of pre-hydrophobated precipitated silica and hydrophilic precipitated silica with a rubber composition containing at least one conjugated diene-based elastomer without an addition of a silica coupling agent or alkoxysilane silica hydrophobtaining agent to the rubber composition;
wherein said pre-hydrophobated precipitated silica is hydrophobated with a hydrophobtaining agent prior to its addition to said rubber composition.

7. The method of claim 6 wherein said hydrophobtaining agent is comprised of at least one of an alkoxysilane, organosiloxysilyl polysulfide and organomercaptoalkoxysilane.

8. The method of claim 6 wherein said hydrophobtaining agent is an organoalkoxysilyl polysulfide comprised of a bis(3-trialkoxysilylalkyl)polysulfide having an average of from about 2 to about 3.8 connecting sulfur atoms in is polysulfidic bridge.

9. The method of claim 6 wherein said hydrophobtaining agent is comprised of an organomercaptoalkoxysilane.

10. The method of claim 6 where the weight ratio of hydrophilic precipitated silica to pre-hydrophobated precipitated silica is at least 1/1.

11. The method of claim 6 wherein said the mixing of the hydrophilic precipitated silica and pre-hydrophobated precipitated silica with the rubber composition is administered:
(A) in the same non-productive mixing step before or after the addition of the pre-hydrophobated precipitated silica, or
(B) in a separate non-productive mixing step following the addition of the pre-hydrophobated precipitated silica, or
(C) in a separate non-productive mixing step following the addition of the pre-hydrophobated precipitated silica with an additional separate non-productive mixing step therebetween, or
(D) in a separate, subsequent productive mixing step in which sulfur and sulfur curatives are added to the rubber composition.

12. The method of claim 6 wherein said method is comprised of at least two sequential preparatory non-productive mixing steps followed by a productive mixing step, which comprises:
(A) blending a pre-hydrophobated precipitated silica with a rubber composition comprised of at least one conjugated diene-based elastomer in at least one preparatory non-productive mixing step in an internal rubber mixer to thereby form a hydrophobated precipitated silica-containing rubber composition (at a temperature of, for example, in a range of from about 135° C. to about 175° C.);
(B) removing said hydrophobated precipitated silica-containing rubber composition from its internal rubber mixer,
(C) blending a hydrophilic additional precipitated silica with said hydrophobated precipitated silica-containing rubber composition in at least one different and subsequent preparatory non-productive mixing step in an internal rubber mixer, to form a rubber composition which contains dual silica moieties in a form of a combination of said pre-hydrophobated precipitated silica and said hydrophilic additional precipitated silica;
wherein said pre-hydrophobated silica is hydrophobated prior to its addition to said rubber composition with at least one hydrophobtaining agent comprised of an alkoxysilane, organosiloxysilyl polysulfide and organomercaptoalkoxysilane.

13. The method of claim 6 wherein said method is comprised of at least one preparatory non-productive mixing step followed by a productive mixing step, which comprises:
(A) blending a pre-hydrophobated precipitated silica with a rubber composition comprised of at least one conjugated diene-based elastomer in at least one preparatory non-productive mixing step in an internal rubber mixer, (at a temperature of, for example, in a range of from about 135° C. to about 175° C.);
(B) blending a hydrophilic precipitated silica with said pre-hydrophobated precipitated silica-containing rubber composition in the same non-productive mixing step in an internal rubber mixer to form a rubber composition which contains dual silica moieties in a form of a combination of said pre-hydrophobated precipitated silica and said hydrophilic precipitated silica,
wherein said pre-hydrophobated silica is hydrophobated prior to its addition to said rubber composition with at least one hydrophobtaining agent comprised of an alkoxysilane, organosiloxysilyl polysulfide and organomercaptoalkoxysilane.

14. The tire of claim 1 wherein said pre-hydrophobated precipitated silica is hydrophobated prior to its addition to said rubber composition with a hydrophobtaining agent comprised of an organoalkoxysilyl polysulfide comprised of a bis(3-trialkoxysilylalkyl)polysulfide having an average of from about 2 to about 3.8 connecting sulfur atoms in is polysulfidic bridge.

15. The tire of claim 1 wherein said pre-hydrophobated precipitated silica is hydrophobated prior to its addition to said rubber composition with a hydrophobtaining agent comprised an organoalkoxysilyl polysulfide comprised of a bis(3-trialkoxysilylalkyl)polysulfide having an average of from about 2 to about 2.6 connecting sulfur atoms in is polysulfidic bridge.

16. The tire of claim 14 wherein said hydrobating agent is comprised of a bis(3-triethoxysilylpropyl)polysulfide.

17. The tire of claim 2 wherein said hydrophobtaining agent is comprised of an alkoxysilane.

18. The tire of claim 2 wherein said hydrophobtaining agent is comprised of an organomercaptoalkoxysilane.

19. The tire of claim 1 where the weight ratio of hydrophilic precipitated silica to pre-hydrophobated precipitated silica is at least 1/1.
